(19) United States
(12) Patent Application Publication
(10) Pub. No.: US 2019/0048831 A1
(43) Pub. Date: Feb. 14, 2019

(54) FRESH AIR PATH HYDROCARBON TRAP SYSTEM

(71) Applicant: GM GLOBAL TECHNOLOGY OPERATIONS LLC, Detroit, MI (US)

(72) Inventors: William L. Villaire, Clarkston, MI (US); Kristin M. DeMare, Scottsdale, AZ (US); Philip A. Yaccarino, Troy, MI (US); Mitchell E. Hart, Grand Blanc, MI (US)

(21) Appl. No.: 15/673,605

(22) Filed: Aug. 10, 2017

(51) Int. Cl. F02M 25/08; B01D 53/04

(52) U.S. Cl. CPC F02M 25/0872; F02M 25/0854; B01D 2257/702; B01D 53/0415; B01D 2253/102; F02M 25/089

(57) ABSTRACT

A system for minimizing hydrocarbon vapor emissions includes a fuel vapor adsorption canister and a fresh air vent line from the fuel adsorption canister to an ambient environment to vent the fuel vapor adsorption canister. The fresh air vent line includes one or more hydrocarbon trap sections. The one or more hydrocarbon trap sections of the fresh air vent line adsorb hydrocarbon emissions from the fuel vapor adsorption canister to minimize hydrocarbon emissions to the ambient environment.

### INTRODUCTION

The present invention relates generally to the field of vehicles and, more specifically, to the management of hydrocarbons within a fresh air vent path of an evaporative emissions system.

In conventional gasoline-powered engines, fuel tank vapor (typically comprising lower molecular weight hydrocarbons) is vented to a canister containing high surface area carbon granules for temporary absorption of fuel tank vapor emissions. Later, during engine operation, ambient air is drawn through the carbon granule bed to purge absorbed fuel vapor from the surfaces of the carbon particles and carry the removed fuel vapor into the air induction system of the vehicle engine. However, some hydrocarbons may not be absorbed by the carbon granules of the canister and may escape to the ambient environment via a canister fresh air vent line.

### SUMMARY

Embodiments according to the present disclosure provide a number of advantages. For example, embodiments according to the present disclosure enable management of hydrocarbon emissions that are not absorbed by a fuel vapor adsorption canister and which may escape to the ambient environment via the fresh air vent line of the canister.

In one aspect, an automotive vehicle includes an engine, a fuel supply coupled to the engine such that a fluid travels between the fuel supply to the engine, a fuel vapor adsorption canister, a first passage from the fuel supply to the fuel vapor adsorption canister, a second passage from the fuel vapor adsorption canister for venting the canister, the second passage including at least one hydrocarbon trap section, and a third passage from the fuel vapor adsorption canister to the engine. The at least one hydrocarbon trap section of the second passage adsorbs hydrocarbon emissions from the fuel vapor adsorption canister to minimize hydrocarbon emissions to an ambient environment.

In some aspects, the at least one hydrocarbon trap section includes at least one trough formed in the second passage and wherein at least a portion of the trough comprises a hydrocarbon adsorbent material.

In some aspects, the second passage is a flexible line including at least one hydrocarbon trap section formed on a portion of an interior surface of the flexible line.

In some aspects, the second passage is a flexible line including a hydrocarbon adsorbent material formed on an entirety of an interior surface of the flexible line.

In some aspects, the automotive vehicle further includes an air filter, and the second passage connects the fuel vapor adsorption canister to the air filter.

In another aspect, a system for minimizing hydrocarbon emissions from an automotive vehicle includes a fuel supply, a fuel vapor adsorption canister, a first passage from the fuel supply to the fuel vapor adsorption canister, and a second passage from the fuel vapor adsorption canister for venting the canister, the second passage including at least one hydrocarbon trap section. The at least one hydrocarbon trap section of the second passage adsorbs hydrocarbon emissions from the fuel vapor adsorption canister to minimize hydrocarbon emissions to an ambient environment.

In some aspects, the at least one hydrocarbon trap section includes at least one trough formed in the second passage and wherein at least a portion of the trough includes a hydrocarbon adsorbent material.

In some aspects, the second passage is a flexible line including at least one hydrocarbon trap section formed on a portion of an interior surface of the flexible line.

In some aspects, the second passage is a flexible line including a hydrocarbon adsorbent material formed on an entirety of an interior surface of the flexible line.

In yet another aspect, a system for minimizing hydrocarbon emissions includes a fuel vapor adsorption canister and a fresh air vent line from the fuel adsorption canister to an ambient environment to vent the fuel vapor adsorption canister, the fresh air vent line including one or more hydrocarbon trap sections. The one or more hydrocarbon trap sections of the fresh air vent line adsorb hydrocarbon emissions from the fuel vapor adsorption canister to minimize hydrocarbon emissions to the ambient environment.

In some aspects, each of the one or more hydrocarbon trap sections includes at least one trough formed in the fresh air vent line and at least a portion of the trough includes a hydrocarbon adsorbent material.

In some aspect, the fresh air vent line is a flexible line including at least one hydrocarbon trap section formed on a portion of an interior surface of the flexible line.

In some aspects, the fresh air vent line is a flexible line including a hydrocarbon adsorbent material formed on an entirety of an interior surface of the flexible line.

### BRIEF DESCRIPTION OF THE DRAWINGS

The present disclosure will be described in conjunction with the following figures, wherein like numerals denote like elements.

FIG. 1 is a schematic diagram of a vehicle having a fresh air path hydrocarbon path system, according to an embodiment.

FIG. 2 is a schematic cross-sectional diagram of a fresh air path hydrocarbon path system, according to an embodiment.

FIG. 3 is a schematic cross-sectional diagram of a fresh air path hydrocarbon path system, according to another embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Fuel evaporative emission control systems have been in use on gasoline engine-driven automotive vehicles for many years. The fuel typically consists of a hydrocarbon mixture. During daytime heating, fuel temperature increases. The vapor pressure of the heated gasoline increases and fuel vapor will flow from any opening in the fuel tank. Normally, to minimize or prevent vapor loss to the atmosphere, the tank is vented through a conduit to a canister which contains suitable fuel adsorbent material.

However, some hydrocarbons may not be trapped by the adsorbent material in the canister and may travel through a fresh air line connected to the canister. To minimize or prevent these breakthrough hydrocarbons from reaching the ambient atmosphere, embodiments discussed herein incorporate adsorbent materials into the fresh air line.

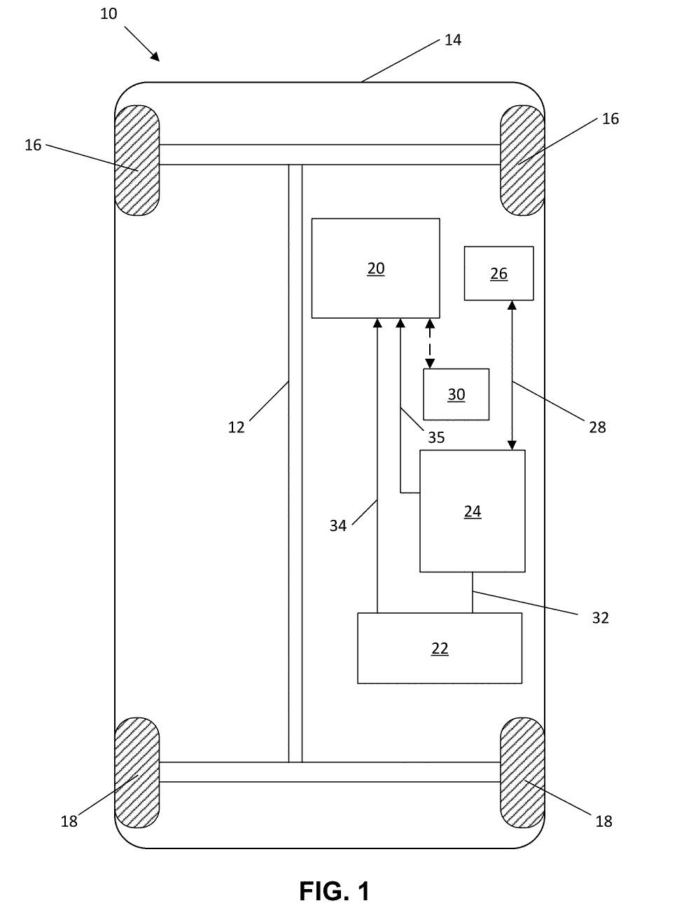

As depicted in FIG. 1, a vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used.

As shown, the vehicle 10 generally includes an engine 20, a fuel supply 22, and an evaporative emissions control system including, in some embodiments, a fuel vapor adsorption canister 24, an air filter 26, a vapor return line 35 connecting the fuel vapor adsorption canister 24 and the engine 20, and a fresh air vent line 28 connecting the fuel vapor adsorption canister 24 and the air filter 26. In some embodiments, the fresh air vent line 28 directly connects the fuel vapor adsorption canister 24 to the ambient environment (that is, the vehicle 10 does not include the air filter 26). The vehicle 10 also includes a controller 30 that is connected via a wired or wireless connection to the engine 20.

In some embodiments, the engine 20 is an internal combustion engine configured to burn a hydrocarbon-based fuel such as gasoline. The fuel supply 22 is, in some embodiments, a fuel tank configured to store and deliver the hydrocarbon-based fuel to the engine 20 via a fuel line 34. A vent line 32 connects the fuel supply 22 with the vapor canister 24. When temperatures rise due to diurnal heating, or when refueling the vehicle, fuel vapor flows from the fuel supply 22 via the vent line 32 to the fuel vapor adsorption canister 24 where the adsorbent material of the fuel vapor adsorption canister 24 traps many of the hydrocarbons of the fuel vapor.

However, some hydrocarbons may break through the fuel vapor adsorption canister 24 and flow through the fresh air vent line 28 toward the ambient atmosphere. To trap these breakthrough hydrocarbons, the fresh air vent line 28 is, in some embodiments, for example and without limitation, made of an adsorbent material or contains one or more adsorbent traps to capture the breakthrough hydrocarbons to minimize or prevent hydrocarbon emissions.

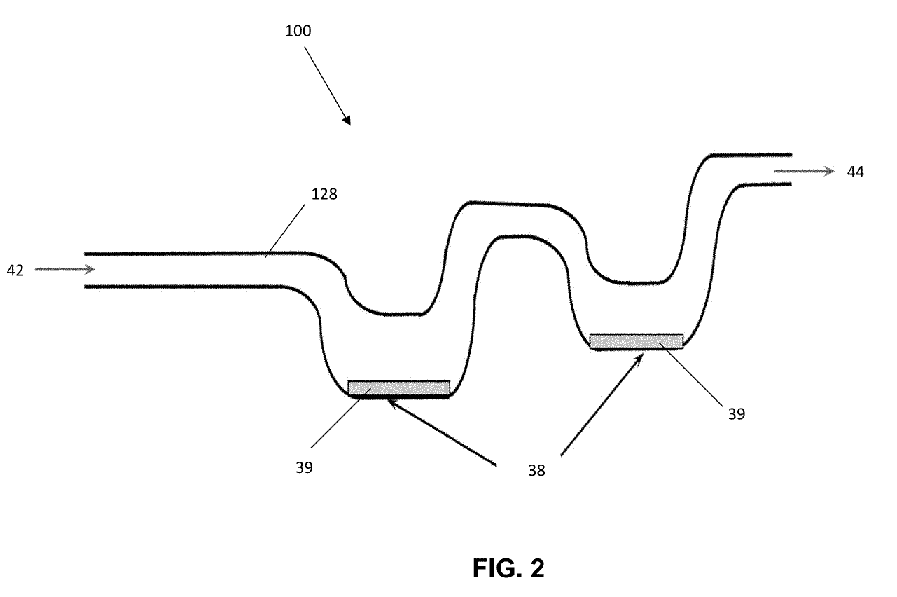

FIG. 2 illustrates a fresh air path hydrocarbon trap system 100, according to an embodiment. The system 100 may be used on a vehicle, such as the vehicle 10, to minimize the release of hydrocarbons to the ambient atmosphere. The system 100 includes a fresh air vent line 128. The fresh air vent line 128 may be a flexible line such that the line can be adjusted to fit within the existing packaging constraints of the vehicle 10.

At least one trap section 38 is formed in the fresh air vent line 128. FIG. 2 includes two trap sections 38; however, other embodiments may include more or fewer trap sections 38. The trap section 38 includes a hydrocarbon adsorption material 39. The size and location of the hydrocarbon adsorbent material 39 can be optimized based upon the available fresh air line routing geometry from the fuel supply 22 to the ambient environment to accommodate varying lengths or flow path cross sections. Additionally, in some embodiments, the adsorbent material 39 can be configured or selected to optimize the effects from the available purge, fuel vapor adsorption canister size, and carbon or other hydrocarbon adsorbent material granule size. In some embodiments, as shown in FIG. 2, the trap sections 38 form troughs in the vent line 128 and the hydrocarbon absorption material 39 is located at the bottom of the troughs.

Fluid, such as air, flows through the vent line 128 from left to right as shown in FIG. 2 (that is, from the fuel vapor adsorption canister 24 and fuel supply 22 toward the ambient environment) and also from right to left (that is, from the ambient environment toward the fuel vapor adsorption canister 24 and fuel supply 22). As air flows in the direction 42 from the fuel vapor adsorption canister 24, the relative heaviness of the hydrocarbons as compared to the fluid flowing through the vent line 128 results in the hydrocarbons falling into the troughs and being adsorbed by the hydrocarbon adsorption material 39 before the air passes out of the vent line 128 to the ambient environment at 44.

Similarly, as air flows in the reverse direction, that is, when air is drawn into the vent line 128 from the ambient environment due to breathing by the fuel supply 22 and/or the fuel vapor adsorption canister 24, and when the vehicle 10 is in purge mode, or the diurnal temperature changes cause the air flow toward the fuel supply 22, the hydrocarbon adsorbent material 39 will release the trapped hydrocarbons back to the fuel vapor adsorption canister 24, fuel supply 22, and/or the engine 20 via the lines 128, 32, 34, and 35.

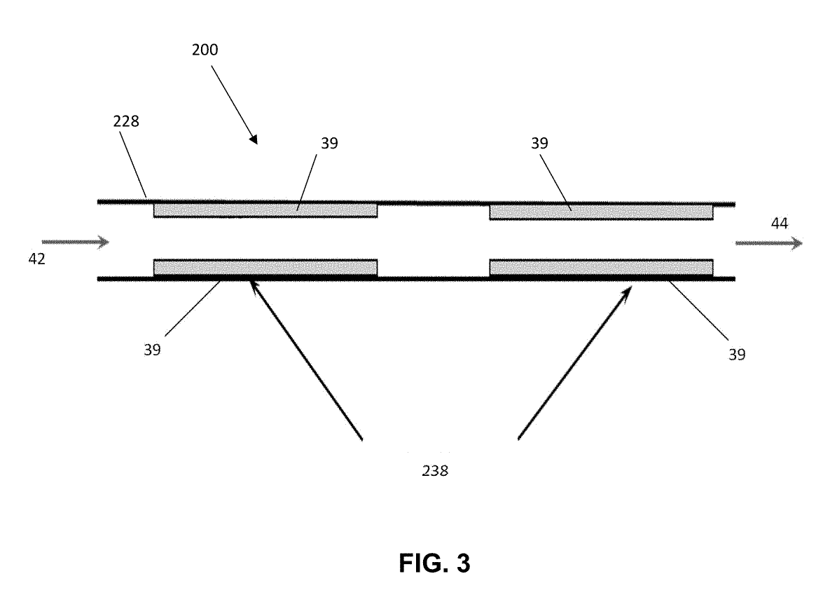

FIG. 3 illustrates a fresh air path hydrocarbon trap system 200, according to an embodiment. The system 200 may be used on a vehicle, such as the vehicle 10, to minimize the release of hydrocarbons to the ambient atmosphere. The system 200 includes a fresh air vent line 228. The vent line 228 may be a flexible line such that the line can be adjusted to fit within the existing packaging constraints of the vehicle 10 and optimized to accommodate the size of the fuel vapor adsorption canister 24, the carbon (or other type of hydrocarbon adsorbent material) granule type, and available purge.

At least one section 238 of the vent line 228 is coated with the adsorbent material 39. In some embodiments, at least a portion of the interior surface of the vent line 228 is coated with the absorbent material 39. As shown in FIG. 3, individual sections 238 of the vent line 228 are coated with the adsorbent material 39; however, in other embodiments, the hydrocarbon adsorbent material 39 may extend continuously along the interior surface of the vent line 228.

As air passes from left to right in the direction 42 through the vent line 228, hydrocarbons that were not trapped by the fuel vapor adsorption canister 24 pass through the vent line 228 and are adsorbed by the hydrocarbon adsorbent material 39 lining the inside surface of the vent line 228. The adsorption of the hydrocarbons in the vent line 228 minimizes or prevents the release of hydrocarbons to the ambient environment.

As air flow in the opposite direction, that is, from the ambient environment toward the fuel vapor adsorption canister 24 and the fuel supply 22, such as, for example and without limitation, when diurnal temperature changes cause the hydrocarbons to be released from the adsorbent material 39, the released hydrocarbons are carried by the airflow toward the fuel vapor adsorption canister 24 and the fuel supply 22.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle, comprising:
an engine;
a fuel supply coupled to the engine such that a fluid travels between the fuel supply to the engine;
a fuel vapor adsorption canister;
a first passage from the fuel supply to the fuel vapor adsorption canister;
a second passage from the fuel vapor adsorption canister for venting the canister, the second passage comprising at least one hydrocarbon trap section; and
a third passage from the fuel vapor adsorption canister to the engine;
wherein the at least one hydrocarbon trap section of the second passage adsorbs hydrocarbon emissions from the fuel vapor adsorption canister to minimize hydrocarbon emissions to an ambient environment.

2. The automotive vehicle of claim 1, wherein the at least one hydrocarbon trap section comprises at least one trough formed in the second passage and wherein at least a portion of the trough comprises a hydrocarbon adsorbent material.

3. The automotive vehicle of claim 1, wherein the second passage is a flexible line comprising at least one hydrocarbon trap section formed on a portion of an interior surface of the flexible line.

4. The automotive vehicle of claim 1, wherein the second passage is a flexible line comprising a hydrocarbon adsorbent material formed on an entirety of an interior surface of the flexible line.

5. The automotive vehicle of claim 1 further comprising an air filter, wherein the second passage connects the fuel vapor adsorption canister to the air filter.

6. A system for minimizing hydrocarbon emissions from an automotive vehicle, comprising:
a fuel supply;
a fuel vapor adsorption canister;
a first passage from the fuel supply to the fuel vapor adsorption canister; and
a second passage from the fuel vapor adsorption canister for venting the fuel vapor adsorption canister, the second passage comprising at least one hydrocarbon trap section;
wherein the at least one hydrocarbon trap section of the second passage adsorbs hydrocarbon emissions from the fuel vapor adsorption canister to minimize hydrocarbon emissions to an ambient environment.

7. The system of claim 6, wherein the at least one hydrocarbon trap section comprises at least one trough formed in the second passage and wherein at least a portion of the trough comprises a hydrocarbon adsorbent material.

8. The system of claim 6, wherein the second passage is a flexible line comprising at least one hydrocarbon trap section formed on a portion of an interior surface of the flexible line.

9. The system of claim 6, wherein the second passage is a flexible line comprising a hydrocarbon adsorbent material formed on an entirety of an interior surface of the flexible line.

10. A system for minimizing hydrocarbon emissions, comprising:
a fuel vapor adsorption canister; and
a fresh air vent line from the fuel vapor adsorption canister to an ambient environment to vent the fuel vapor adsorption canister, the fresh air vent line comprising one or more hydrocarbon trap sections;
wherein the one or more hydrocarbon trap sections of the fresh air vent line adsorb hydrocarbon emissions from the fuel vapor adsorption canister to minimize hydrocarbon emissions to the ambient environment.

11. The system of claim 10, wherein each of the one or more hydrocarbon trap sections comprises at least one trough formed in the fresh air vent line and wherein at least a portion of the trough comprises a hydrocarbon adsorbent material.

12. The system of claim 10, wherein the fresh air vent line is a flexible line comprising at least one hydrocarbon trap section formed on a portion of an interior surface of the flexible line.

13. The system of claim 10, wherein the fresh air vent line is a flexible line comprising a hydrocarbon adsorbent material formed on an entirety of an interior surface of the flexible line.
